(19) United States
(12) Patent Application Publication
(10) Pub. No.: US 2009/0280323 A1
(43) Pub. Date: Nov. 12, 2009

(54) Use of a fixing aid

(75) Inventors: Christian Harder, Hamburg (DE); Annemarie Muller, Hamburg (DE); Gerhard Bir, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa SE, Hamburg (DE)

(21) Appl. No.: 12/437,215

(22) Filed: May 7, 2009

(30) Foreign Application Priority Data
May 9, 2008 (DE) 10 2008 023 020.0

(51) Int. Cl. C09J 103/02; B32B 7/12

(52) U.S. Cl. 428/354; 106/162.1; 106/206.1

(57) ABSTRACT

A laminating composition for producing an adhesive tape having a sheetlike carrier, having at least a polysaccharide component and a surfactant component, and the adhesive tape produced and having carrier sheets colaminated by the laminating composition.

The invention relates to the use of specific pressure-sensitive adhesive (PSA) tapes for flying splice (flying reel change) as practised, for example, in paper converting machines or printing machines with paper webs or the like.

This technique enables splicing to be carried out on reel change without stopping the machine. In a simplified description, the reel to be newly inserted is provided at its leading edge with a pressure-sensitively adhering area which, after the reel has been accelerated to the web speed of the machine, is brought adjacent to the end of the web of the expiring reel and bonded to it, as a result of which the leading edge of the replacement reel is drawn by the expiring web into the machine. The PSA areas required are produced using pressure-sensitive adhesive tapes. In the case of flying splice, these tapes are either double-sidedly pressure-sensitively adhering tapes, with which the webs are bonded in an overlapping formation (web over web), or else, in many cases, are splicing tapes (end to end) of sufficient width which adhere pressure-sensitively on one side.

Although the principle has become established in practice for decades, its technical implementation has had to be continually adapted to the increased web speeds and web widths of the machines. Thus within three decades web speeds have been increased from approximately 600 m/min to the present-day levels of up to 2500 m/min, and machine widths from approximately 2 m to approximately 8 m nowadays. The associated, relatively high forces which act on the splices mean that, even with a somewhat reduced web speed during the splicing operation, it is necessary to improve the adhesive compositions and to prepare the splice in a carefully worked-out manner. A machine stoppage due to web breakage at such speeds and web widths is the cause of very high costs of loss (outage time and reject product during the start-up phase).

A particularly large amount of time and care in preparing the splice is required to fix the leading edge to the replacement reel. Prior to splicing, indeed, it is necessary to bring the new reel to a peripheral speed which corresponds approximately to the web speed. For this operation it is necessary for the leading edge, which carries the PSA area applied for splicing, to adhere firmly to the surface of the reel by means of fixing aids. At the high speeds, even slight fluttering of this web surface hinders full-area bonding to the expiring web, and leads to breakage. As soon as the bond has been produced, on the other hand, the fixing aids must be detached in order that the leading edge can separate from the reel surface. Pressure-sensitively adhering paper labels, for example, are used as such fixing aids, these labels possessing a more or less defined tensile strength as a result of choice of the paper and/or by means of specific geometry, and being stuck onto the reel by hand, in a defined number, so that the leading edge is fixed to the underlying area of the following turn of the reel. Immediately after the splicing of the two webs, the fixing aids are torn apart by the web tension.

For reliable splice preparation, and to avoid the time-consuming and not always reliable manual fixing, pressure-sensitively adhering splicing tapes have been developed which comprise in integrated form not only the adhesive areas provided for splicing but also the fixing aid for the leading edge. Divided up in the longitudinal direction, these adhesive tapes possess on their backing material two striplike zones, one zone being double-sidedly or single-sidedly pressure-sensitively adhering for the splicing operation and being stuck onto (in the case of double-sided pressure-sensitive adhesion) or in part under (in the case of single-sided pressure-sensitive adhesion) the leading edge of the replacement reel. The second, likewise pressure-sensitive adhesive zone, which is arranged on the adhesive tape adjacent to the first zone, at a greater or lesser distance from it, serves, by means of its adhesive area lying on the underside of the adhesive tape, for fixing to the following turn which is formed by the reel surface.

WO 95/29115 describes a splicing tape where the integrated fixing aid is fastened to the reel surface by means of a weakly adhering, reversibly adhering adhesive composition. The reversibly adhering coating is intended to ensure that during the splicing operation the fixture is detached readily and without leaving sticky residues on the reel surface.

This procedure has not become established in practice, since the strength levels of the reversible bond are dependent on the nature of the type of paper to be converted and hence are not constant. Furthermore, the PSA area of the fixing aid remains uncovered on the underside of the paper web and, during the converting process, is passed over the hot drying cylinders of the paper machine, depositing sticky particles which contaminate the paper, soil the drying felts and wires, and if allowed to accumulate substantially may cause breaks by causing the web to stick to drying cylinders.

Similarly, in DE 40 33 900 A, web fixing is carried out with a weakly pressure-sensitively adhering section in conjunction with the splicing zone.

EP 0 418 527 A describes a splicing method especially for flying reel change in a printing machine. Here, the integrated, pressure-sensitively adhering fixing aid is separated from the splice zone, following the bonding of the webs, by means of an incorporated predetermined breakage point. The predetermined breakage point used is a longitudinal perforation of the backing material in the adhesive tape between the pressure-sensitive adhesive films for the splice zone and fixing zone. An advantage with this method is that the pressure-sensitively adhering areas remain covered, after splicing, by non-adhesive substrates and, consequently, no sticky surfaces are passed through the printing machine or the like. A disadvantage, on the other hand, is the poorly defined breaking strength of the predetermined breakage point in the form of a perforation. The fluctuations in strength in this case may be considerable. Moreover, separation via the individual perforations takes place jerkily in the manner of a touch-and-close fastener. Because of the individual tensile strength peaks which occur in this case, it is possible, even with small weaknesses of individual perforation interstices, for the entire assembly to tear prematurely in a manner of a touch-and-close fastener. For printing machines with web speeds of around approximately 800 m/min, this principle may be sufficient; with the substantially faster-running paper converting machines, improved solutions to the problem are desirable.

U.S. Pat. No. 5,702,555 A describes a method of releasably securing web ends to reel surfaces, release taking place in a defined manner, using a double-sidedly pressure-sensitively adhering tape which comprises, between the pressure-sensitively adhering coatings, a readily cleavable paper backing which acts as a predetermined breakage zone. When the fixture is detached, the pressure-sensitive layers remain on the paper web, with the paper backing positioned between them cleaving more or less centrally and so breaking the bond between the leading edge and the underlying turn of the reel. In this case, the pressure-sensitive adhesive layers remain covered by the two relatively thin paper webs formed in the cleavage, so that no sticky areas are passed through the machine.

Specifications DE 196 28 317 A and DE 196 32 689 A describe pressure-sensitive adhesive tapes constructed especially for flying splice in high-speed paper machines and comprising particularly readily cleaving paper as intermediate carrier material for an integrated fixing aid of the leading edge.

WO 99/46196 describes, inter alia, a repulpable splicing tape with an integrated fixing aid, the multi-ply fixing aid comprising incorporated therein a water-soluble polymer layer in contact with a silicone or organofluorine-compound release layer as a predetermined breakage point. The cleavage force is established by way of the coating thickness and release quality of the release agents. A disadvantage with this fixing aid is the unwanted introduction of such highly active surface-active agents into the paper recycling process. Moreover, the establishment of the cleavage force in the desired narrow tolerances by means of changes in the minimum coat thicknesses of such release agents requires a high level of technological complexity.

EP 1 076 026 A describes the use of a fixing aid on the underside of a splicing tape, the splicing tape being adhered by means of the fixing aid to the second-from-top sheet of a wound reel, and the splicing tape being adhered at the same time to the start of the topmost sheet of the wound reel, in such a way that at least part of the adhesive top face of the splicing tape that is opposite the fixing aid is open for adhesive coupling to a high-speed sheet of another reel which is in the process of being unwound, the fixing aid being adhered to the underside of the splicing tape and being composed of a carrier material which is formed from two colaminated sheetlike materials, the lamination forming a predetermined breakage zone, and the fixing aid being pressure-sensitively adhesive on its underside. Use is made in particular as binders of modified starches, which as release additives contain talc, stearyl derivatives or dispersions of polymeric release agents.

In summary, it is evident that flying reel change in modern coating plants is a complex operation where, owing to the high speeds and large masses—in the tonne range—to be accelerated, even marginal errors or weak points in this process may lead to considerable losses. For this reason, the paper factories normally keep statistics concerning the failure rate during splicing. Accordingly, there is a need for further optimization. Essential to this is the minimization of tensile stress peaks during splicing: Consequently, instantaneous jerky acceleration forces are to be avoided as far as is possible. This is a problem in connection with the sudden detachment of the fixing aids for the leading edge during splice-forming. The separation of the fixing aids, which are required to secure the leading edge of the replacement reel against the underflow of air or flaglike detachment during rotary acceleration to web speed, using comparatively high holding forces, generates a significant tension peak in the paper web.

It is an object of the invention to minimize these tension peaks by means of an onwardly developed procedure.

### DESCRIPTION OF THE INVENTION

The invention teaches an innovative laminating composition for producing a fixing aid, a thus-produced fixing aid in the form of or as part of an adhesive tape (adhesive splicing tape), more particularly a pressure-sensitive adhesive tape, and also the use of a fixing aid and, respectively, of an adhesive splicing tape for implementing flying reel changes with an integrated fixing aid for the leading edge of the replacement reel, where the deficiencies described do not occur, or at least not to the same extent. Essential to this utility is the incorporation of a readily and “soft”-cleavable predetermined breakage zone with close breakage tolerances for the detachment of the fixing aid from the reel surface.

The invention provides, among other things, an adhesive tape comprising a carrier composed of an assembly of two sheets which are colaminated by means of a laminating composition based on at least one polysaccharide component and a surfactant component, and further comprising at least two layers of adhesive, of which one is provided above the carrier and the other below the carrier.

This adhesive tape may constitute merely the described fixing aid or may more particularly be an adhesive splicing tape comprising such a fixing aid and further components.

For the production of the fixing aid of the invention, two webs, especially two paper webs, are laminated to one another. This lamination is performed such that it produces the desired predetermined breakage zone.

The laminating composition used in accordance with the invention is a composition which in addition to a binder, more particularly a polysaccharide component, comprises at least one surfactant component, which serves more particularly as a release agent. The surfactant component may be a single surfactant, but may also be a surfactant component composed of two or more surfactants.

The laminating adhesive may if required advantageously comprise further components, including, in particular, elasticizing additives (also elasticizing agents below). In one very preferred procedure the polysaccharide component is starch, gum arabic or derivatives of the aforementioned compounds.

The binder component may additionally also be, for example, a stearate, especially magnesium stearate and calcium stearate. The composition of the binder component may also be such that a mixture of starch with one or more further binders is used. Starch as a binder has the essential advantage that the laminating composition possesses very good screen-printability.

Laminating compositions that are particularly preferred in accordance with the invention have a polysaccharide fraction of up to 98%, more preferably of up to 85% to 95%, more preferably still of 90% to 95%, by weight. With particular preference it is possible to use starch derivatives, especially hydroxypropyl ethers based on potato starch. One such starch is available, for example, from Emslandstarke under the name Emsol K55.

The surfactant content is very preferably 2% to 20%, more preferably 5% to 15%, most preferably 5% to 10%, by weight. The above fraction figures are based, both for the polysaccharide and for the surfactant component, on the mixture of surfactant and polysaccharide, specifically in each case in the form of the amount based on the solids fraction. For the production of the laminating composition, solvent, more particularly water, is present as well, preferably in fractions of 50% to 80%. For producing the laminating adhesives it is possible in particular to add the solid surfactant to a 20% to 40% strength aqueous solution of the polysaccharide component.

Examples of further possible additives to the laminating composition are talc, Ca stearate and/or release copolymers with stearyl groups, used in fractions of 30%-80% by weight. Talc may more particularly be used as a filler in order to bring about screen-printability!

For elasticization, polypropylene glycols or polyethylene glycols have proved to be highly suitable, preferably in amounts between 0-15% by weight. In this case the products of relatively high molecular mass that are solid at room temperature are primarily used. Further elasticizing agents which can be used to good effect in major proportions are gum arabic and plastics having a similar profile of properties.

The laminating composition is preferably coated onto a paper carrier or the like, using an applicator unit suitable for aqueous dispersions, and is lined in the wet state with a second paper carrier or the like, and subsequently dried. If required, the measures customary in papermaking, such as rewetting, calendering and levelling of the resultant assembly, may be employed. The film thickness of the laminating composition after drying is situated preferably within a range of 5 to 20 g/m², more particularly 5 to 10 g/m².

The above-described assembly can then be coated with adhesive, especially pressure-sensitive adhesive (PSA). In this case, depending on the requirements of the application, either the same or different adhesives, or PSAs, can be applied to the top face and to the bottom face. The fixing aid thus produced can be employed in this form for flying reel change; alternatively, the fixing aid may also serve as a component for equipping a more comprehensive adhesive tape (also referred to as an adhesive splicing tape), especially pressure-sensitive adhesive tape. In this case there are a multiplicity of possible embodiments, and, with inclusion of release papers, it is possible to produce roll product forms of adhesive tapes with single-sidedly adhesive splicing zones or double-sidedly adhesive splicing zones.

In a first embodiment the fixing aid is composed of a carrier with a predetermined breakage point of the type described above, in other words, more particularly, two colaminated paper webs, the carrier being provided on its top face and on its bottom face with one adhesive each, use being made more particularly of pressure-sensitive adhesives. In that case it is possible to use identical adhesives (PSAs) on the top face and on the bottom face; alternatively, the adhesives (PSAs) may be selected differently, in particular by being adapted to the substrate to which they are bonded in the application.

A further embodiment represents an adhesive tape which in particular includes a fixing aid having the above-described construction. In that case, the fixing aid is provided on the opposite side of the pressure-sensitive adhesive zone that is intended for splicing, more particularly as described in DE 196 28 317 Al, preferably as described in FIG. 1 therein. Further examples of adhesive tapes with an integrated fixing aid, which can be configured in accordance with the invention, are found in specifications DE 196 28 317 A, DE 198 30 674 A, DE 199 02 179 A, DE 199 58 223 A, DE 100 58 956, DE 101 23 981, WO 03/20623 A, WO 03/24850 A, DE 102 10 192 A, DE 102 58 667, DE 102004028312A, DE 10 2005 051 181 A, the intention not being, of course, to confine the invention to these embodiments.

For greater ease of handling, the fixing aid or the adhesive splicing tape with fixing aid may be lined in particular with a double-sidedly releasing carrier material, especially siliconized paper, and advantageously is wound to a roll together with this material for the purpose of storage or of sale.

With particular preference the fixing aid and/or the adhesive splicing tape are of elastic form.

In selecting appropriate laminating compositions, it should be ensured that the dried films possess no adhesive force even at relatively high temperatures, so that the areas exposed after cleavage do not contaminate machine parts or product. For use in paper machines and printing machines it is desirable for no constituents of the fixing aid or adhesive splicing tape to disrupt the recycling of papers. Splice zones cut out in the course of further processing may then be recycled without problems. Consequently, water-based formulations of the laminating composition, comprising customary papermaking auxiliaries, are particularly advantageous. Binders which may be used include, for example, modified starches, or binders as have long been used for wet adhesive tapes.

Surfactants are used as release agents. Particular preference is given to selecting nonionic and/or anionic emulsifiers. These surfactants may be monomeric, olgiomeric or else polymeric in nature. It is preferred to use surfactants with long side chains, especially those having side chains with 8 to 18 C atoms. Surfactants which have proved to be particularly preferable are polar surfactants with relatively long-chain alkyl radicals, especially such surfactants with alkyl chains having at least 8, more preferably at least 12, C atoms.

The following compounds have emerged as being especially advantageous release agents for the present invention:

sodium octadecylsulphosuccinate, sodium dialkylsulphosuccinate, Na n-dodecyl sulphate, sodium lauryl sulphate, ammonium lauryl sulphate, sodium oleylcetyl alcohol sulphate, fatty alcohol polyglycol ethers, fatty alcohol ethoxylate and nonylphenol ethoxylate.

Disodium n-octadecylsulphosuccinate (ODSS) has proved to be particularly outstanding as a release agent for the inventive purpose. When a laminating composition on this basis was used, it was possible to produce adhesive tapes that could be used with particular success (no errors) for flying reel change.

The following overview provides a list of commercially available products which can be used to outstanding effect to produce the laminating composition of the invention. Identification as trade marks has not been carried out, without detriment to the rights of the respective owners.

| | | | Manufacturer | |
|---|---|---|---|---|
| Trade name | Manufacturer | Chemical characterization | details | |
| ODSS, Aerosol 18P | Cytec | Na | | anionic |
| | | octadecylsulphosuccinate | | |
| Disponil SUS IC 680 | Cognis | dialkylsulphosuccinate, | no details | anionic |
| | | Na salt | | |
| Texapon K12 PA 1 | Cognis | Na n-dodecyl sulphate | C12 | anionic |
| Sulfopon 101 sp. RHD | Cognis | Na lauryl sulphate | C12/C16 | anionic |
| Texapon A | Cognis | NH₄ lauryl sulphate | C8/C14 | anionic |
| Sulfopon 0680 | Cognis | oleylcetyl alcohol sulphate, | no details | anionic |
| | | Na salt | | |
| Disponil LS 500 | Cognis | fatty alcohol polyglycol ether | C12/C14 | nonionic |
| Disponil TA 11 | Cognis | fatty alcohol ethoxylate | C16/C18 | nonionic |
| Disponil NP 10 | Cognis | nonylphenol ethoxylate | no details | nonionic |

A further preferred variant for producing the desired predetermined breakage zone consists in the partial, non-full-area lamination of two carrier webs. For this purpose, for example, one paper web is coated with discrete areas of laminating composition by means of rotary screen printing, colaminated wet with the second carrier web, and dried. The spacing, diameter and film thickness of the areas are predetermined by the screen design. Preference is given to using screens of 14 to 100 mesh and 7% to 60% open area. Screens with 40 mesh and screens with 50 mesh, for example, have proved to be outstandingly suitable. The amount of dried laminating composition applied is established within the range 5 to 25 g/m², especially 5 to 10 g/m².

Screen printing is carried out using relatively high-viscosity, pastelike, non-foaming aqueous preparations whose solids content comprises, for example, anionic potato starch or corn starch. Elasticizing additions such as polypropylene glycols or polyethylene glycols and/or release agents may also be used in amounts that are compatible with the principal constituent. The cleavage force is determined not only by the amount of release agent but also by screen design and solids concentration.

In order to obtain a clean printed image without smearing, the elastic component in the flow behaviour of the aqueous preparation must be kept low so as to avoid stringing. This can be achieved, for example, by additions of talc or small amounts of very finely divided silica gel or other thickeners.

By means of differing distribution and/or size of the areas of laminating composition in the predetermined breakage zone, it is possible to establish varying cleavage forces within this zone. By this means, when the fixing aid cleaves during the splicing operation, the cleavage force can be kept low, for example, at the beginning in the edge region of the fixing zone, can increase gradually as the detachment process progresses, towards the middle, by means of an increasing density or size of sites of adhesion and can fall again towards the end of cleavage by means of a corresponding reduction in the adhesion points. In this way it is possible to avoid tensile stress peaks during the splicing operation, and the cleavage forces of the fixing aids may be adjusted in a defined manner to the requirements of a wide variety of different paper grades and splice geometries.

When selecting the carrier papers or films it is necessary to take account of the fact that for an undisrupted conversion process the thickness of the splice should be as low as possible. Consequently, the maximum thickness, especially paper thickness of the individual carrier webs should be limited preferably to 70 g/m², and the overall thickness of the assembly for the fixing aid should not exceed a maximum of 140 g/m². In order to reduce the thickness of the assembly it is also possible to laminate a relatively thin paper web onto a thicker, wet-coated carrier web. A wet-strength treatment of the paper webs used is permissible in order to avoid instances of warping but should be performed in particular in a manner which still permits sufficient repulpability under operating conditions.

If wet lamination is not possible in the case of very thin papers, it is also possible to use hot-melt adhesives, preferably repulpable materials based on polyvinylpyrrolidone and/or corresponding copolymers or hydroxypropylcellulose, blended with polar waxes, resins and release waxes such as stearic acid, for example, and, if required, with preferably water-soluble plasticizers. After one of the paper carrier webs has been coated with a hot-melt adhesive of this kind, the second web is laminated on thermally. The hot-melt adhesives should as far as possible have high softening ranges above 120° C., so that on contact with hot drying cylinders in the paper machine little or no hot-melt adhesive particles (“stickies”) are deposited at these areas. Since hot-melt adhesives are classified as potential contaminants in papermaking, this variant of lamination is not used with preference.

The colaminated carrier web is subsequently provided on both sides with a shear-resistant and preferably repulpable pressure-sensitive adhesive composition in film thicknesses of preferably in each case 15-40 g/m², cut into web widths of about 100—approximately 400 mm, and wound into rolls with insertion of a double-sided release carrier material, e.g. siliconized paper. The fixing aids obtained in this way can subsequently be bonded to a very wide variety of splicing tapes. In DE 196 28 317 A1, an example of this is described with a single-sidedly pressure-sensitively adhesive-coated splicing tape. Anchoring of the fixing aid on the pressure sensitive adhesive splicing tape is also possible, for example, with a fixing aid with a pressure-sensitive adhesive coating on one side only. Bonding in this case may take place, for example, with a glue coat. The splicing tapes thus equipped with the integrated fixing aid may be provided as roll product in the customary manner, such as, for example, with release paper inserted.

The predetermined breakage zone generally becomes active in the form of adhesive fracture between the laminating composition and the laminated paper web. The release force for cleaving the predetermined breakage zone when the fixing aid is cleaved, the cleaved halves both being separated at an angle of 90° to the laminated assembly at a speed of 300 mm/min, should preferably be established within a range of 3 to 40, especially 5 to 35 cN/cm. The easier-to-cleave assemblies are intended primarily for the splicing of sensitive or lightweight papers. For special applications, of course, it is also possible to exceed the abovementioned limits.

In applications where repulpability of the splicing zones is not required, the solution to the problem can be simplified accordingly. In that case, the films used as carrier materials for the fixing aid may also be colaminated using, as laminating composition, hot-melt adhesives having release additives, such as, for example, release waxes based on polyvinyl stearylcarbamate or talc, etc., within blend limits as specified above. Binders in the form of aqueous dispersions based, for example, on polyacrylate or poly(butadiene-styrene) with water-miscible release additives are also suitable in that case.

The invention is illustrated below with reference to examples, without wishing to restrict it unnecessarily thereby.

Experimental Series 1 (Table 1)

A laminating composition is prepared from an aqueous solution of the polysaccharide and from the corresponding surfactant, in the proportions indicated in Table 1. The binder is used in the form of an aqueous polysaccharide solution, which is obtained by dissolving the starch derivative at 80 to 85° C. to form a homogeneous solution with the corresponding amount of solid (B1 to B9) [Emsol K 55 was used in particular as a 35% strength solution (B1, B2), Emcol DA 1344 as a 30% strength solution (B3) and as a 25% strength solution (B4 to B6). Gum arabic was used as a 60% strength solution].

As comparative experiments (C1 to C4) a laminating composition is prepared from a polymeric release agent (“Tremul”) and starch. The polymeric release agent (Tremul) is obtained as follows: styrene and maleic acid mono-N-stearyl amide are subjected to free-radical copolymerization in a molar ratio of 3 to 1 at 85° C. in ammoniacal, aqueous medium at a pH of 9 without the addition of emulsifiers, to give a polymer dispersion with 30% by weight solids.

To prepare the binder, the polysaccharide derivative is dissolved at 80 to 85° C. in water to give a homogeneous solution having the solids content specified in Table 1.

Polysaccharide derivatives used are the starch derivatives Emsol K55 (modified, hot-water-soluble hydroxypropyl ethers based on potato starch) and also Emcol DA1344 (hydroxypropylated potato starch with an amylase fraction of about 22%), both available from Emslandstarke GmbH, and also gum arabic.

A paper carrier with a basis weight of 60 g/m² (DREWSEN Spezialpapiere GmbH & Co. KG) is coated with the laminating composition prepared as described above (Examples B1 to B10, Comparative Examples C1 to C4) by rotary screen printing (screen type LR, 40 mesh, 20% open area, 125 p thickness, 300 y hole diameter, 25% paste volume). Tissue paper with a 30 g/m² basis weight is laminated onto the wet coating. Thereafter the assembly is dried at 120° C. and smoothed by rewetting. The coat thickness of the dried laminating composition in each case is specified in Table 1 (coatweight line in g/m²).

Subsequently the assembly is coated on both sides with 20 g/m² of repulpable pressure-sensitive adhesive.

Two papers are placed oppositely from both sides onto the test specimen and are pressed gently with the finger in order to avoid inclusions of air. Thereafter, using a manual roller, the assembly is quickly overrolled twice per side in order to achieve an excellent bond strength.

The bond is to be produced such that on one side the ends of the papers protrude beyond the test body and so are able to serve as grip tabs.

Centrally in the assembly, using a steel ruler, strips 15 mm wide are cut out in a length of about 20 cm. The two grip tabs are then pulled apart by hand until cleavage of the paper test specimen can be recognized.

The test body is then clamped by the grip tabs into the tensile testing machine, and the remainder of the strip is pulled apart at a constant speed of 300 mm/min.

Care should be taken to ensure that the result is not falsified by contact and sticking between the opposite edges of the adhesive tape at the margin of the test body. The cleavage strength of the paper is expressed in cN/cm. The average is formed from 5 values measured.

The testing of the cleavage force in a tensile testing machine with a cleavage speed of 300 mm/min produces the values set out in Table 1.

TABLE 1

| Component | | C1 | C2 | C3 | C4 | B1 | B2 | B3 | B4 | B5 | B6 | B7 | B8 | B9 |
|---|---|---|---|---|---|---|---|---|---|---|---|---|---|---|
| Emsol K55 | % by | 53 | — | — | — | 92.5 | 90 | — | — | — | — | — | — | — |
| | wt. | | | | | | | | | | | | | |
| | (solids) | | | | | | | | | | | | | |
| Emcol DA | % by | — | — | — | — | — | — | 95 | 92.5 | 90 | 85 | — | — | — |
| 1344 | wt. | | | | | | | | | | | | | |
| | (solids) | | | | | | | | | | | | | |
| Gum arabic | % by | — | 50 | 53 | 60 | — | — | — | — | — | — | 95 | 92.5 | 90 |
| | wt. | | | | | | | | | | | | | |
| | (solids) | | | | | | | | | | | | | |
| Tremul for | % by | 47 | 50 | 47 | 40 | — | — | — | — | — | — | | | |
| comparison | wt. | | | | | | | | | | | | | |
| | (solids) | | | | | | | | | | | | | |
| ODSS, | % by | — | — | — | — | 7.5 | 10 | 5 | 7.5 | 10 | 15 | 5 | 7.5 | 10 |
| Aerosol | wt. | | | | | | | | | | | | | |
| 18P | (solids) | | | | | | | | | | | | | |
| Screen- | | very | good | good | good | very | very | greasy, formation of “pointed | | | | moderate, formation of | | |
| printability* | | good | | | | good | good | hats” | | | | “pointed hats”, viscosity low | | |
| Coat weight | g/m² | 10.0 | 12.3 | 11.6 | 10.2 | 10.1 | 9.8 | 5.0 | 7.7 | 8.9 | 6.0 | 15.4 | 15.5 | 16.1 |
| Cleavage | cN/cm | 11.2 | 3.3/2.8 | 3.2/3.3 | 3.3/8.6 | 30-50 | 20 | 10 | 61/56 | 38/42 | 47/51 | 4.5/4.5 | 8.3/0.2 | 2.2/2.9 |
| forces | | | | | | | | | | | | | | |
| (release | | | | | | | | | | | | | | |
| forces) | | | | | | | | | | | | | | |
| Ø | cN/cm | 12.3 | 2.9 | 3.2 | 5.9 | 30 | 20 | 10 | 59 | 40 | 50 | 4.5 | 4.2 | 2.6 |
| Cleavage | cN/cm | 10-16 | 3.8/4.4 | 4.2/7.4 | 3.4/10.2 | 17-26 | 30-37 | 10-20 | 36/39 | 49/47 | 37/40 | 6.2/15.8 | 7.3/13.1 | 7.4/ |
| forces | | | | | | | | | | | | | | 12.0 |
| (release | | | | | | | | | | | | | | |
| forces) | | | | | | | | | | | | | | |
| Ø | cN/cm | 13.0 | 4.1 | 5.8 | 6.0 | 21 | 31 | 10 | 37 | 48 | 38 | 11 | 10 | 10 |

*screen-printability; the visual assessment relates to the subjective appearance

Outstanding results are obtained when using a laminating composition with 90% to 95% by weight of a hot-water-soluble hydroxypropyl ether based on potato starch (in this case, by way of example, Emsol K55) as a binder component and 5% to 10% by weight of disodium n-octadecylsulphosuccinate (ODSS) as a surfactant component.

Experimental Series 2 (Table 2)

In a second experimental series, in analogy to the mode of preparation described in experimental series 1, laminating compositions comprising 90% of the starch derivative and 10% surfactant (based on the solids contents; laminating composition obtainable by adding the solid surfactant to a 35% strength aqueous solution of the starch derivative) are subjected to measurement. The test specimens are again produced in the same way as for experimental series 1.

The polysaccharide components used are the starch derivatives Emsol K55 (Emslandstarke; see above) and also Pure-FLO F (modified edible starch based on amylose-free maize containing amylopectin [“waxy maize”]; available from National Starch & Chemical Corporation).

The surfactants used can be seen from Table 2.

Table 2 shows that the surfactants listed are likewise highly suited to the production of the laminating composition.

TABLE 2
Formula: 90% starch + 10% surfactant (solids/solids)
Screen printing 40 mesh on 60 g Drewsen paper, wet lamination with 30 g
tissue paper, drying: 5 min at 80° C.

| | | | | Coat weight | Visual |
|---|---|---|---|---|---|
| Example | Starch | Surfactant | Viscosity | [g/m²] | assessment* |
| B11 | Emsol K55 | ODSS | screen-printable | 9.8 | very good |
| B12 | Emsol K55 | Texapon K12 | screen-printable | 7.4 | good |
| B13 | Emsol K55 | Sulfopon 101 | screen-printable | 10.3 | good |
| B14 | Emsol K55 | Texapon A | screen-printable | 10.1 | good |
| B15 | Emsol K55 | Sulfopon 0680 | screen-printable | 6.3 | good |
| B16 | Emsol K55 | Disponil LS500 | viscosity somewhat low | 7.1 | good |
| B17 | Emsol K55 | Disponil TA11 | screen-printable | 9.2 | good |
| B18 | Pure-FLO F | Disponil SUS IC 680 | screen-printable | 3.5 | good |
| B19 | Pure-FLO F | ODSS | screen-printable | 3.8 | very good |
| B20 | Pure-FLO F | Disponil TA11 | screen-printable | 3.9 | good |

*screen-printability; the visual assessment relates to the subjective appearance

The results reproduced in Tables 1 and 2 demonstrate that the proposed invention has succeeded in ensuring a minimization, relative to the prior art, in relation to the load on the splice that forms in the immediate vicinity of the leading web edge, and in producing a reduction in the total or partial tearing of the paper surface on which the fixing aid is fastened. Particularly in the case of the manufacture of relatively thin, sensitive papers, the stress peaks must be minimized, while on the other hand the reliable fixing of the leading web edge to the reel also necessitates relatively high strengths. On account of these requirements, the predetermined breakage point must be made functional within extremely close, defined tolerances.

As described in the introduction, the generation of predetermined breakage points by means of more or less easily cleavable papers, whose cleavage resistance is lowered essentially by means of a high fraction of short fibres and fillers, is considered to be more favourable than the use of reversibly bonding pressure-sensitive adhesive coatings. A disadvantage associated with paper cleavage in the thickness of the paper (Z direction) is that a low cleavage force is difficult to establish and cannot be defined within narrow limits. Accordingly, a narrow design of the predetermined breakage tolerances is unsuccessful. Moreover, paper containing a high proportion of filler and short fibres in order to reduce the cleavage resistance in the Z direction is very brittle. This leads to a brittle, inelastic and jerky cleaving, and so predetermined breakage points of this kind do not cleave in an elastically “soft” manner, and make no contribution to reducing instanteous peak loads in the splicing operation.

1. Laminating composition for producing an adhesive tape having a sheetlike carrier, comprising at least one polysaccharide component and at least one surfactant component.

2. Laminating composition according to claim 1, wherein the polysaccharide component is present in a fraction of up to 98% by weight, based on the total weight of polysaccharides and surfactants.

3. Laminating composition according to claim 1, wherein the polysaccharide component is selected from the group consisting of starch derivatives.

4. Laminating composition according to claim 1, wherein the surfactant content is 2% to 20%by weight, based on the total weight of polysaccharides and surfactants.

5. Laminating composition according to claim 1, wherein the surfactant component is one or more members selected from the group consisting of disodium n-octadecylsulphosuccinate, sodium dialkylsulphosuccinate, Na n-dodecyl sulphate, sodium lauryl sulphate, ammonium lauryl sulphate, sodium oleylcetyl alcohol sulphate, fatty alcohol polyglycol ethers, fatty alcohol ethoxylate and nonylphenol ethoxylate.

6. Laminating composition according to claim 1, which in the dried state possesses no adhesive force.

7. Adhesive tape comprising a carrier composed of an assembly of two sheets which are colaminated by means of a laminating composition according to claim 1, and further comprising at least two layers of adhesive, of which one is provided above the carrier and the other below the carrier.

8. Adhesive tape according to claim 7, which exhibits a release force of 3 to 40 cN/cm for cleaving a predetermined breakage zone during the cleavage of the colaminated sheets of the adhesive tape, measured for a separation of the cleavage halves at an angle of 900 to the laminated assembly and at a speed of 300 mm/min.

9. Adhesive tape according to claim 8, wherein the release force for cleaving the predetermined breakage zone is established by means of a full-area lamination or a partial, discontinuous coating of the laminating composition by way of the number and/or size of adhesive areas such as may be produced by means of screen printing or gravure printing.

10. Adhesive tape according to claim 7, wherein the materials of the colaminated sheets of the adhesive tape are films or paper.
